(19) United States
(12) Patent Application Publication
(10) Pub. No.: US 2007/0100594 A1
(43) Pub. Date: May 3, 2007

(54) Method for constructing a kinetic model allowing the mass of hydrogen sulfide produced by aquathermolysis to be estimated

(76) Inventors: Violaine Lamoureux-Var, Chatou (FR); Francois Lorant, Thiais (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/588,365

(22) Filed: Oct. 27, 2006

(30) Foreign Application Priority Data
Oct. 27, 2005 (FR) 05/11.126

(51) Int. Cl. G06G 7/48

(52) U.S. Cl. 703/10

(57) ABSTRACT

Method for constructing a kinetic model allowing the mass of hydrogen sulfide produced by aquathermolysis within a rock containing crude oil to be estimated. The crude oil and the rock are described according to four chemical compound fractions: NSO fraction, aromatics fraction, resin fraction and insolubles fraction. A kinetic model describing the mass of hydrogen sulfide produced as a function of time, of temperature and of the evolution of the sulfur mass distribution in said fractions is then defined. In this kinetic model, the sulfur contained in the NSO and resin fractions generates hydrogen sulfide and is partly incorporated in the insolubles and aromatics fractions. The kinetic parameters of the model are then calibrated from aqueous pyrolysis experiments carried out in an inert and closed medium, while checking that all of the sulfur initially contained in the oil is entirely dispersed in all the fractions.

### FIELD OF THE INVENTION

The present invention relates to a method for constructing a kinetic model allowing the mass of hydrogen sulfide produced by aquathermolysis within a rock containing crude oil to be estimated.

Aquathermolysis is defined as a set of physico-chemical reactions between a crude oil and steam, at temperatures ranging between 200° C. and 300° C. A definition is given in the following document:
Hyne J. B. et al., 1984, “Aquathermolysis of heavy oils”, 2nd Int. Conf., The Future of Heavy Crude and Tar Sands, McGraw Hill, New York, Chapter 45, p. 404-411.

In particular, the present invention relates to a method for predicting the hydrogen sulfide (H₂S) masses that can be generated during the injection of steam in petroleum reservoirs for crude oil recovery.

Within this context of enhanced crude oil recovery, the method then allows to check whether the H₂S emissions remain below the legal maximum level (according to countries, around 10 to 20 vol.ppm) and to deduce the steam injection conditions or to dimension the H₂S re-injection processes and the wellhead acid gas processing plants, or to select sufficiently resistant production materials.

### BACKGROUND OF THE INVENTION

The following documents, mentioned in the description hereafter, illustrate the prior art:
Attar A., Villoria A.; Verona D., Parisi S., 1984, “Sulfur functional groups in heavy oils and their transformations in steam injected enhanced oil recovery.”, Symposium on the chemistry of enhanced oil recovery, American Chemical Society, v. 29, No. 4, p 1212-1222,
Belgrave J. D. M., Moore R. G., Ursenbach R. G, 1997, “Comprehensive kinetic models for the aquathermolysis of heavy oils”, Journal of Canadian Petroleum Technology, v 36,n 4,p 38-44.
Chakma A., 2000, “Kinetics and Mechanisms of Asphltenes cracking during petroleum recovery and processing operations”, Asphaltenes and asphalts. 2. Developments in Petroleum Science, 40B, Elsevier, pp. 129-148.
Gillis K. A., Palmgren Claes, thimm H. F., 2000, “Simulation of Gas Production in SAGD”, SPE/Petroleum Society of CIM, 65500.
Hayashitami M. et al., 1978, “Thermal cracking models for Athabasca oil sands oils”, SPE 7549, SPE annual technical conference and exhibition, Hourin, pp 1-4.
Koseoglu and Phillips, 1987; “Kinetics of non-catalytic hydrocracking of Athabasca bitumen”, Fuel, n^{o}66, 741.
Thimm H. F., 2000, “A general theory of gas production in SAGD operations”, Canadian International Petroleum Conference Proceedings, 2000-17.

Hydrogen sulfide (H₂S) is both a highly corrosive and very toxic or even lethal gas beyond a certain concentration. Now, this gas can be generated in various types of natural conditions: Thermal Sulfate Reduction (TSR); Bacterial Sulfate Reduction (BSR), organosulfur compound cracking, etc. It can also be generated under conditions created by man, such as steam injection in heavy crude reservoirs that often contain high sulfur contents (Thimm, 2000 ; Gillis et al., 2000). Thus, predicting the H₂S concentration of the gas produced during enhanced recovery using steam injection helps, on the one hand, to reduce production costs by adapting recovery and treating processes and, on the other hand, to prevent emissions that are dangerous to man and to the environment.

A technical problem is the prediction of the proportion of H₂S generated according to the quality of the crude, the reservoir conditions and the steam injection conditions. If the risk of H₂S production is to be predicted by means of a reservoir model (used by flow simulators), a kinetic H₂S genesis model is obligatory. Models of this type have already been proposed in the literature.

Attar et al. (1984) describe a kinetic H₂S genesis model that describes the kinetic conversion of sulfur-containing groups for H₂S genesis under steam injection conditions. This model, although predictive, requires in return complex determination of the value of the many parameters thereof.

Belgrave et al. (1997) describe a kinetic H₂S formation model under steam injection conditions. On the one hand, this model describes the evolution of the oil fractions (and not the evolution of the sulfur in these fractions). This model is actually not dedicated to H₂S genesis only. On the other hand, this model is constructed from results of heavy crude pyrolysis without water. Now, as underlined by Belgrave et al., water has a quite significant effect on pyrolysis products. Furthermore, Köseoglu and Phillips (1987) (in Chakma, 2000) have carried out pyrolysis experiments with water and deduced therefrom that the presence of water had an influence on the values of the kinetic parameters. Finally, in this model, the non-hydrocarbon gases, especially H₂S, are assumed to come from asphaltenes only.

Besides kinetic models, there are known reservoir models allowing the H₂S produced during steam injection in a reservoir to be calculated:

Thimm (2000) proposed a reservoir model calculating very simply the production of H₂S under steam injection conditions. This model does not calculate the amount of H₂S in the reservoir, but it presupposes it from H₂S production measurements in certain fields. Its model is therefore non predictive and non generalizable.

Gillis et al. (2000) published their first H₂S production simulation results under SAGD (Steam Assisted Gravity Drainage) recovery conditions, with the STARS reservoir model (CMG, Canada). They therefore take account of the thermodynamic behaviour of H₂S and the amounts of H₂S present in the reservoir are presupposed according to the aforementioned Thimm theory. There therefore is no H₂S genesis model and modelling thereof is neither generalizable nor predictive.

There are also methods closely related to the method according to the invention, for determining the parameters of kinetic models from pyrolysis experiments on bitumen.

Hayashitani et al. (1978) provide a thermal cracking model for Athabasca bitumen. This model describes the production of gas from asphaltenes but it does not detail the gaseous constituents (H₂S in particular). Furthermore, it does not take account of the effect of water on the reactions and it is based on cracking experiments carried out at temperatures (360° C.-422° C.) that are too high to represent the aquathermolysis temperatures (200° C.-300° C.).

Köseoglu and Phillips (1987) (in Chakma, 2000) have taken account of the effect of water on Athabasca bitumen cracking and proposed a kinetic model wherein the gases are generated from maltenes (saturates+aromatics+resins) and not asphaltenes. However, no detail is given concerning H₂S. These methods do therefore not allow the amount of H₂S formed to be precisely estimated because they do not distinguish the H₂S from the other gaseous constituents.

The method according to the invention allows a kinetic model to be constructed to estimate the mass of hydrogen sulfide produced by aquathermolysis of a rock containing crude oil, by describing the evolution of the sulfur distribution in the oil fractions and the insolubles fraction.

### SUMMARY OF THE INVENTION

The invention relates to a method for constructing a kinetic model allowing to estimate the mass of hydrogen sulfide produced by a rock containing crude oil and subjected to contact with steam at a temperature T for a contact time t, generating an aquathermolysis reaction. The method comprises the following stages:

a) describing the rock, the crude oil and the hydrogen sulfide produced according to a characterization by chemical compound fractions comprising at least the following fractions:

the NSO, aromatics and resin fractions to describe the oil,

the insolubles fraction containing compounds that are insoluble in dichloromethane and n-pentane, to describe the rock,

the hydrogen sulfide fraction to describe the hydrogen sulfide,

b) defining a kinetic model describing, from kinetic parameters, the mass of hydrogen sulfide produced as a function of said contact time t, as a function of said temperature T and as a function of the evolution of the sulfur distribution in said chemical compound fractions, wherein:

at least part of the sulfur contained in said NSO fraction produces hydrogen sulfide and at least another part is incorporated in said insolubles and aromatics fractions,

at least part of the sulfur contained in said resin fraction produces hydrogen sulfide and at least another part is incorporated in said insolubles and aromatics fractions,

all of the sulfur initially contained in the oil and the rock is entirely dispersed in at least one of said chemical compound fractions during aquathermolysis,

c) calibrating said kinetic parameters from aqueous pyrolysis experiments carried out on at least one sample of said rock.

According to the invention, it may be necessary to carry out at least as many pyrolysis experiments as there are kinetic parameters to be calibrated, and these aqueous pyrolysis experiments can be carried out for different temperatures and different contact times.

In this case, the different temperatures can be selected within a range where aquathermolysis has notable effects, i.e. the various temperatures can be above 200° C. and/or below 300° C.

After said pyrolysis experiments, it is possible to measure:
the mass of hydrogen sulfide produced for each temperature and each time of contact between the steam and the oil,
the mass distribution of the sulfur in each one of said fractions.

The sulfur mass distribution of each fraction can be measured by extraction and separation of the fractions by means of solvents, then by weighing and elementary analysis of the fractions. The mass of hydrogen sulfide produced after said pyrolysis experiments can be measured by gas chromatography.

The initial conditions of said kinetic model can be determined from rock samples by separating, prior to pyrolysis, said fractions by means of solvents and by carrying out elementary analyses of said fractions thus separated.

The kinetic parameters of the model can be calibrated by means of an inversion technique.

According to a particular application of the invention, the mass of hydrogen sulfide produced by a petroleum reservoir during crude oil recovery by steam injection in said reservoir can be estimated by carrying out the following stages:
calibrating said parameters from rock samples from said reservoir,
estimating said mass of hydrogen sulfide produced by said reservoir at any time, by means of a reservoir model and from said kinetic model.

It is then possible to check that the mass of hydrogen sulfide produced by said petroleum reservoir remains below the legal maximum level, determine steam injection conditions required to reduce H₂S emissions, dimension H₂S re-injection processes in the reservoir and/or dimension wellhead acid gas processing plants.

### BRIEF DESCRIPTION OF THE FIGURES

Other features and advantages of the method according to the invention will be clear from reading the description hereafter of non limitative embodiment examples, with reference to the accompanying figures wherein:

FIGS. 1A and 1B show the evolution of the sulfur distribution in the various fractions of an oil and of a rock from aqueous pyrolysis experiments carried out in an inert and closed medium at different temperatures: 260° C. (FIG. 1A) and 320° C. (FIG. 1B),

FIG. 2 shows a comparison between the sulfur mass distributions in each one of the fractions calculated with the kinetic model and measured,

FIG. 3A shows the evolution of the sulfur mass distribution in the various fractions (RMS) for a 24-h contact time (t_{c}),

FIG. 3B shows the evolution of the sulfur mass distribution in the various fractions (RMS) for a 203-hour contact time (t_{c}).

### DETAILED DESCRIPTION

The method according to the invention allows the mass of hydrogen sulfide produced by aquathermolysis within a rock containing crude oil to be estimated. Aquathermolysis is defined as the sum of the chemical reactions between a heavy oil and steam (Hyne et al., 1984).

The method first comprises defining a kinetic model describing the hydrogen sulfide (H₂S) genesis as a function of the evolution of the sulfur distribution in said chemical compound fractions. Then a set of pyrolysis experiments is carried out on the rock in order to calibrate this kinetic model. Finally, from this calibrated kinetic model, the amount of hydrogen sulfide produced by the rock subjected to contact with steam for a time t at a temperature T can be determined. Chemical characterization of the crude oil contained in the rock A characterization by chemical compound classes common in the industry is the S.A.R.A. characterization, described for example in the following document:
F. Leyssale, 1991, “Étude de la pyrolyse d'alkylpolyaromatiques appliquée aux procédés de conversion des produits lourds du pétrole. Influence du noyau aromatique sur le comportement thermique”, Thèse de l'Université Paris VI, Réf IFO n^{o} 39 363.

It consists in describing the crude oil in four fractions: saturates, aromatics, resins and asphaltenes.

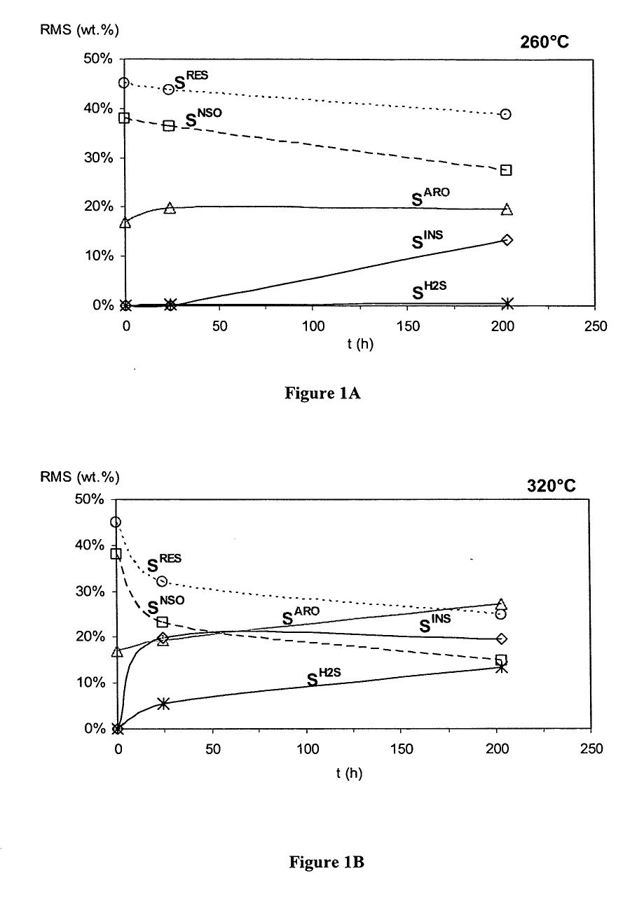

After aquathermolysis experiments carried out in the laboratory on rock samples, it is observed, as illustrated in FIGS. 1A, 1B, that the fraction insoluble in n-pentane and dichloromethane, a fraction essentially consisting of mineral, plays an important part in the evolution of the sulfur distribution during the hydrogen sulfide genesis.

This is the reason why, according to the invention, we describe not only the crude oil, but the whole made up of the crude oil and the mineral part, that is split up according to the following five fractions:

A fraction corresponding to the oil compounds insoluble in pentane:

1—The NSO compounds: the NSO correspond to the compounds insoluble in n-pentane at 43° C. but soluble in dichloromethane at 43° C., rich in nitrogen (N), sulfur (S), oxygen (O) and metals. These compounds mainly consist of asphaltenes, but they also contain some resins.

Three fractions corresponding to the oil compounds soluble in n-pentane at 43° C., the maltenes:

2—The saturated compounds: maltenes with saturated hydrocarbon chains.

3—The aromatic compounds: maltenes with hydrocarbon chains having one or more aromatic rings.

4—The resins: maltenes comprising asphaltic material (the second heaviest fraction of the oil).

These three fractions are separated from one another by liquid adsorption chromatography of MPLC type (Medium Pressure Liquid Chromatography).

A fraction corresponding to the oil compounds insoluble in n-pentane and dichloromethane:

5—The insolubles: this fraction essentially consists of mineral solid and it can contain an organic part.

Definition of a Kinetic Model

The effect of aquathermolysis mainly depends on two variables:

the time of contact between the steam and the rock, denoted by t,

the temperature at which the chemical reactions occur, denoted by T.

Definition of a kinetic model describing the hydrogen sulfide genesis (H₂S) thus consists in defining a system of equations allowing to determine the amount (the mass for example) of hydrogen sulfide produced at any time t, for a given temperature T.

The methodology according to the invention, allowing such a kinetic model to be defined, describes on the one hand that the sulfur contained in the NSO fraction generates hydrogen sulfide and is partly incorporated in the insolubles and aromatic fractions and, on the other hand, and identically, that the sulfur contained in the resin fraction generates hydrogen sulfide and is partly incorporated in the insolubles and aromatic fractions. The sulfur in the asphaltenes and the sulfur in the resins are furthermore assumed not to interact. Besides, several reactions are considered to co-exist in parallel within each fraction, these reactions being characterized by different time constants (kₐ₁, kₐ₂, . . . , kₐₙ, k_{b1}, k_{b2}, . . . , k_{bm}). Finally, the saturates fraction is assumed to contain no sulfur. The model is then written as follows:

$$\{ \begin{matrix}{S}^{NSO} {\to }^{{a}_{1 ,} {k}_{a 1} ( T )} {α}_{11} {S}^{{H}_{2} S} + {α}_{12} {S}^{INS} + {α}_{13} {S}^{ARO} \\ {S}^{NSO} {\to }^{{a}_{2 ,} {k}_{a 2} ( T )} {α}_{21} {S}^{{H}_{2} S} + {α}_{22} {S}^{INS} + {α}_{23} {S}^{ARO} \\ … \\ {S}^{NSO} {\to }^{{a}_{n ,} {k}_{an} ( T )} {α}_{n 1} {S}^{{H}_{2} S} + {α}_{n 2} {S}^{INS} + {α}_{n 3} {S}^{ARO} \\ {S}^{RES} {\to }^{{b}_{1 ,} {k}_{b 1} ( T )} {β}_{11} {S}^{{H}_{2} S} + {β}_{12} {S}^{INS} + {β}_{13} {S}^{ARO} \\ {S}^{RES} {\to }^{{b}_{2 ,} {k}_{b 2} ( T )} {β}_{21} {S}^{{H}_{2} S} + {β}_{22} {S}^{INS} + {β}_{23} {S}^{ARO} \\ … \\ {S}^{RES} {\to }^{{b}_{m ,} {k}_{bm} ( T )} {β}_{m 1} {S}^{{H}_{2} S} + {β}_{m 2} {S}^{INS} + {β}_{m 3} {S}^{ARO}\end{matrix} \} , ∀ t \geq 0 \qquad ( 1 )$$

with:

S^{NSO}: the sulfur mass distribution in the NSO fraction

S^{H}^{₂}^{S}: the sulfur mass distribution in the hydrogen sulfide fraction

S^{INS}: the sulfur mass distribution in the insolubles fraction

S^{ARO}: the sulfur mass distribution in the aromatics fraction

S^{RES}: the sulfur mass distribution in the resin fraction

T: the temperature

n and m: the required numbers of parallel sulfur, respectively NSO and resin conversion equations to describe the experimental data.

α₁₁, α₁₂, α₁₃, . . . , αₙ₁, αₙ₂, αₙ₃: stoichiometric coefficients

β₁₁, β₁₂, β₁₃, . . . , βₘ₁, βₘ₂, βₘ₃: stoichiometric coefficients

a₁, a₂, . . . , aₙ: distribution coefficients

b₁, b₂, . . . , bₘ: distribution coefficients.

The latter four groups of coefficients are parameters of the kinetic model to be defined. They verify the following closure equations:

$$\{ \begin{matrix}{α}_{11} + {α}_{12} + {α}_{13} = 1 \\ {α}_{21} + {α}_{22} + {α}_{23} = 1 \\ … \\ {α}_{n 1} + {α}_{n 2} + {α}_{n 3} = 1 \\ {β}_{11} + {β}_{12} + {β}_{13} = 1 \\ {β}_{21} + {β}_{22} + {β}_{23} = 1 \\ … \\ {β}_{m 1} + {β}_{m 2} + {β}_{m 3} = 1 \\ {a}_{1} + {a}_{2} + … + {a}_{n} = 1 \\ {b}_{1} + {b}_{2} + … + {b}_{m} = 1\end{matrix} \} \qquad ( 2 )$$

aᵢ (respectively bᵢ): represent the proportion of sulfur in the NSO (respectively resin) fraction reacting according to the equation characterized by time constant kₐᵢ (respectively k_{bi}).

kₐ₁, kₐ₂, . . . , kₐₙ, k_{b1}, k_{b2}, . . . , k_{bm}: the time constants; they are assumed to depend only on temperature T:

$$\{ \begin{matrix}{k}_{a 1} ( T ) = {A}_{a 1} exp ( - \frac{{E}_{a 1}}{R . T} ) \\ … \\ {k}_{an} ( T ) = {A}_{an} exp ( - \frac{{E}_{an}}{R . T} ) \\ {k}_{b 1} ( T ) = {A}_{b 1} exp ( - \frac{{E}_{b 1}}{R . T} ) \\ … \\ {k}_{bm} ( T ) = {A}_{bm} exp ( - \frac{{E}_{bm}}{R . T} )\end{matrix} \} , ∀ T \geq {20}^{∘} C . \qquad ( 3 )$$

R being the perfect gas constant (R=8.314 J.K⁻¹.mol⁻¹)

Aₐ₁, Aₐ₂, . . . , Aₐₙ, A_{b1}, A_{b2}, . . . , A_{bm}, the pre-exponential factors and Eₐ₁, Eₐ₂, . . . , Eₐₙ, E_{b1}, E_{b2}, . . . , E_{bm} the activation energies have to be calibrated experimentally.

The methodology according to the invention, allowing the kinetic model to be defined, also describes that all of the sulfur initially present in the oil is entirely found in all of the fractions selected. In other words, the model respects the sulfur mass conservation principle. Thus, a third system of equations completes the kinetic model:
S^{NSO}+S^{H}^{₂}^{S}+S^{INS}+S^{ARO}+S^{RES}=1, ∀t≧0 (4)

A first-order kinetic scheme derived from systems (1) and (3) and constrained by system (2) and mass conservation equation (4), as well as by initial conditions (S₀^{NSO}, S₀^{RES}, S₀^{INS} and S₀^{ARO}), allows to calculate the evolution of the sulfur distribution in the various fractions as a function of time and of temperature. This kinetic scheme consists of all the velocity laws assumed to be of order 1 and of the reactions taken into account in the process affecting the sulfur during aquathermolysis:

$$\{ \begin{matrix}\frac{ⅆ}{ⅆ t} {S}_{NSO} = {\sum }_{i = 1}^{n} {a}_{i} \frac{ⅆ}{ⅆ t} {( {S}_{NSO} )}_{i} with \text{:} \frac{ⅆ}{ⅆ t} {( {S}_{NSO} )}_{i} = - {{k}_{ai} ( {S}_{NSO} )}_{i} \\ \frac{ⅆ}{ⅆ t} {S}_{RES} = {\sum }_{j = 1}^{m} {b}_{j} \frac{ⅆ}{ⅆ t} {( {S}_{RES} )}_{j} with \text{:} \frac{ⅆ}{ⅆ t} {( {S}_{RES} )}_{j} = - {{k}_{bj} ( {S}_{RES} )}_{j} \\ \frac{ⅆ}{ⅆ t} {S}_{{H}_{2} S} = - {\sum }_{i = 1}^{n} {α}_{i 1} {a}_{i} \frac{ⅆ}{ⅆ t} {( {S}_{NSO} )}_{i} - {\sum }_{j = 1}^{m} {β}_{j 1} {b}_{j} \frac{ⅆ}{ⅆ t} {( {S}_{RES} )}_{j} \\ \frac{ⅆ}{ⅆ t} {S}_{INS} = - {\sum }_{i = 1}^{n} {α}_{i 2} {a}_{i} \frac{ⅆ}{ⅆ t} {( {S}_{NSO} )}_{i} - {\sum }_{j = 1}^{m} {β}_{j 2} {b}_{j} \frac{ⅆ}{ⅆ t} {( {S}_{RES} )}_{j} \\ \frac{ⅆ}{ⅆ t} {S}_{ARO} = - {\sum }_{i = 1}^{n} {α}_{i 3} {a}_{i} \frac{ⅆ}{ⅆ t} {( {S}_{NSO} )}_{i} - {\sum }_{j = 1}^{m} {β}_{j 3} {b}_{j} \frac{ⅆ}{ⅆ t} {( {S}_{RES} )}_{j}\end{matrix} \} , ∀ t \geq 0$$

By simultaneously integrating all of these velocity laws as a function of time and temperature, we show that the proportions of various sulfur-containing fractions can be calculated by means of the following function system (5), defined as ∀t≧0:

$$\{ \begin{matrix}\begin{matrix}{S}^{NSO} ( t , T ) = {Φ}_{1} [ {S}_{0}^{NSO} , {a}_{1 ,} {A}_{a 1} , {E}_{a 1} , … , {a}_{n ,} {A}_{an} , {E}_{an} , t , T ] \\ {S}^{RES} ( t , T ) = {Φ}_{2} [ {S}_{0}^{RES} , {b}_{1 ,} {A}_{b 1} , {E}_{b 1} , … , {b}_{m ,} {A}_{bm} , {E}_{bm} , t , T ] \\ {S}^{{H}_{2} S} ( t , T ) = {Ψ}_{1} [ \begin{matrix}{S}_{0}^{NSO} , {S}_{0}^{RES} , {a}_{1 ,} {A}_{a 1} , {E}_{a 1} , … , {a}_{n ,} {A}_{an} , {E}_{an} , \\ {b}_{1 ,} {A}_{b 1} , {E}_{b 1} , … , {b}_{m ,} {A}_{bm} , {E}_{bm} , {α}_{11} , … , {α}_{n 1} , \\ {β}_{11} , … , {β}_{m 1} , t , T\end{matrix} ]\end{matrix} \\ \begin{matrix}{S}^{INS} ( t , T ) = {S}_{0}^{INS} + {Ψ}_{2} [ \begin{matrix} {S}_{0}^{NSO} , {S}_{0}^{RES} , {a}_{1 ,} {A}_{a 1} , {E}_{a 1} , … , {a}_{n ,} {A}_{an} , \\ {E}_{an} , {b}_{1 ,} {A}_{b 1} , {E}_{b 1} , … , {b}_{m ,} {A}_{bm} , {E}_{bm} , \\ {α}_{12} , … , {α}_{n 2} , {β}_{12} , … , {β}_{m 2} , t , T\end{matrix} ] \\ {S}^{ARO} ( t , T ) = {S}_{0}^{ARO} + {Ψ}_{3} [ \begin{matrix}\begin{matrix} {S}_{0}^{NSO} , {S}_{0}^{RES} , {a}_{1 ,} {A}_{a 1} , {E}_{a 1} , … , {a}_{n ,} {A}_{an} , \\ {E}_{an} , {b}_{1 ,} {A}_{b 1} , {E}_{b 1} , … , {b}_{m ,} {A}_{bm} , {E}_{bm ,}\end{matrix} \\ {α}_{13} , … , {α}_{n 3} , {β}_{13} , … , {β}_{m 3} , t , T\end{matrix} ]\end{matrix}\end{matrix} \} \qquad ( 5 )$$

with:

S₀^{NSO}: the sulfur mass distribution in the NSO fraction at t=0

S₀^{RES}: the sulfur mass distribution in the resin fraction at t=0

S₀^{INS}: the sulfur mass distribution in the insolubles fraction at t=0

S₀^{ARO}: the sulfur mass distribution in the aromatic fraction at t =0.

The form of functions Φ₁, Φ₂, Ψ₁, Ψ₂, and Ψ₃ depends on the thermal history imposed during aquathermolysis. For example, in the particular case of an isothermal thermal range, these functions are of the form as follows:

Φ₁: a function of the form: λ₁ exp(−kₐ₁.t)+ . . . +λₙ exp(−kₐₙ.t)

Φ₂: a function of the form: λ₁ exp(−k_{b1}t)+ . . . +λₘ exp(−k_{bm}t), ∀t≧0

Ψ₁: a function of the form:
λ₁{1−esp(−kₐ₁t)}+ . . . +λₙ{1−exp(−kₐₙt)}+μ₁{1−exp(−k_{b1}t)}+ . . . +μₘ{1−exp(−k_{bm}t)}, ∀t≧0

Ψ₂: a function of the form:
λ₁{1−exp(−kₐ₁t)}+ . . . +λₙ{1−exp(−kₐₙt)}+μ₁{1−exp(−k_{b1}t)}+ . . . +μₘ{1−exp(−k_{bm}t)}, ∀t≧0

Ψ₃: a function of the form:
λ₁{1−exp(−kₐ₁t)}+ . . . +λₙ{1−exp(−kₐₙt)}+μ₁{1−exp(−k_{b1}t)}+ . . . +μₘ{1−exp(−k_{bm}t)}, ∀t≧0

The amount of hydrogen sulfide generated during aquathermolysis, as a function of time and of temperature, is then proportional to the evolution of the sulfur contained in the hydrogen sulfide:

$${H}_{2} S ( t , T ) = \frac{{M}_{{H}_{2} S}}{{M}_{S}} \times {m}_{S} \times {S}^{H 2 S} ( t , T ) , ∀ t \geq 0 \qquad ( 6 )$$

with:

H₂S(t,T): the mass of H₂S produced at temperature T and during a contact time t.

$$\frac{{M}_{{H}_{2} S}}{{M}_{S}}$$

:the ratio of the molecular mass of the hydrogen sulfide to the molecular mass of the sulfur.

mS: the total mass of sulfur in the rock.

It is then necessary to determine, on the one hand, the initial conditions (S₀^{NSO}, S₀^{RES}, S₀^{INS} and S₀^{ARO}) and, on the other hand, the unknown parameters of the model:
the pre-exponential factors: Aₐ₁, Aₐ₂, . . . , Aₐₙ, A_{b1}, A_{b2}, . . . , A_{bm}
the activation energies: Eₐ₁, Eₐ₂, . . . , Eₐₙ, E_{b1}, E_{b2}, . . . , E_{bm}

the stoichiometric coefficients: α₁₁, α₁₂, α₁₃, . . . , and αₙ₁,αₙ₂, αₙ₃
β₁₁, β₁₂, β₁₃, . . . , βₘ₁, βₘ₂, βₘ₃
the distribution coefficients: α₁, α₂, . . . , αₙ and b₁, b₂, . . . , bₘ.

Model Calibration

To calibrate the parameters of the kinetic model, aqueous pyrolysis experiments (aquathermolysis in the laboratory) are carried out on rock samples, the mass of sulfur contained in each fraction of the sample being determined thereafter. The sulfur mass distributions in the various fractions are deduced therefrom (mass of sulfur contained in a fraction divided by the total mass of sulfur contained in the sample). These experiments are carried out for various temperatures T and different contact times t_{c}.

Then, by means of an inversion technique, the parameters of the model are determined. Inversion, as it is known to specialists, consists in defining a quadratic error function to be minimized so that the results of the model are as close as possible to the measured results. According to the method, the quadratic error function is defined between the measured mass distribution values and the calculated mass distribution values. Any inversion method is suitable.

An example of an experimental protocol is described hereafter within the context of the study of a reservoir rock into which steam is injected for enhanced heavy oil recovery.

Aquathermolysis Experiments

In order to evaluate the amount of H₂S generated by a rock in contact with steam, aqueous pyrolyses (aquathermolysis) are carried out in a closed medium, after which the H₂S formed is quantified. Aqueous pyrolyses consist in heating a rock sample with steam, at a pressure of 100 bars, and at a constant temperature T. This temperature is selected to be the most representative possible of the in-situ conditions of the rock, considering the experimentation time constraints. This temperature is selected within the temperature range where aquathermolysis has notable effects. For example, the temperature at which the steam is injected into the reservoirs ranges between 200° C. and 300° C. The temperature of the steam in the steam chamber of the reservoir ranges between the temperature of the formation (10° C.-100° C.) and the injection temperature (200° C.-300° C.). Knowing that aquathermolysis reactions have significant effects above 200° C. for conventional production times (Hyne et al., 1984), the critical temperatures for in-situ aquathermolysis are above 200° C. and cannot exceed 300° C. Thus, the experimental temperatures within the context of steam injection in a reservoir can range between 200° C. and 300° C.

The reagents are the reservoir rock homogenized by crushing and deionized water. The amount of water added is calculated so as to have the same volumes of oil and of water considering the amount of formation water already present in the rock. These reagents are housed in a gold tube of inside diameter 10 mm, outside diameter 11 mm and height 5 to 6 cm. This gold tube is sealed in a neutral atmosphere by ultrasound. This welding technique is ultra-fast and weakly exothermic: the gold is heated to less than 80° C. for less than a second, so that the reagents are not heated before aquathermolysis starts. The tube is then placed in an autoclave that controls the pressure and the temperature. The pressure is set at 100 bars.

To evaluate the parameters of the kinetic model as a function of temperature, it is necessary to perform several aquathermolyses at different temperatures, all within the range wherein aquathermolysis has notable effects (200° C.-300° C.). It is clear that the more tests are carried out at different temperatures, the more accurate the model.

According to an embodiment example, four temperatures were selected within the sensitive range (200° C.-300° C.) and one slightly above this range in order to cover a wider range of conversion of sulfur to H₂S without increasing the experimentation times too much. Thus, according to a method of operation, the aquathermolysis experiments were carried out at the following temperatures Tₚ: 240° C., 260° C., 280° C., 300° C., and 320° C. Still according to this embodiment, for each pyrolysis carried out at different temperatures, measurements are performed with two different contact times t_{c}: t_{c}=24 h and t_{c}=203 h.

Measurement of the Amounts of H₂S Generated

After an aquathermolysis of duration t_{c} at a temperature T, the gold tube is opened in an empty line connected to a Toepler pump known to the man skilled in the art. This device allows all the gases contained in the gold tube to be recovered and quantified. The gases are then stored in a glass tube so as to analyze the molecular composition thereof with a gas chromatograph. The number of moles of H₂S formed during aquathermolysis is deduced therefrom.

We thus obtain the mass of H₂S produced at temperature T and corresponding to a contact time t_{c} between the steam and the oil: H₂S(t_{c}, Tₚ)

Measurement of the Sulfur Distribution in the Oil and Rock Fractions

Combined with this H₂S gas, the heavy products are also recovered and weighed: the C14+ maltenes, soluble in n-pentane, the NSO, insoluble in n-pentane but soluble in dichloromethane, and the residue, insoluble both in dichloromethane and n-pentane. The C₆-C₁₄ hydrocarbons (hydrocarbons having between 6 and 14 carbon atoms) and water are assumed to be present in negligible amounts, they are therefore not quantified.

Approximately 60 ml solvent is added per gram of reservoir rock, while keeping the same amount of solvent for all the experiments of equal duration. For example, 60 ml solvent are added for tubes heated during t_{c}=203 h and 200 ml solvent for tubes heated during t_{c}=24 h, which contain more rock. To solubilize the C14+ maltenes, the gold tube is first stirred with the n-pentane at 44° C. under reflux for 1 hour. Then the solution is filtered to separate the NSO and the insolubles from the C14+ maltenes solubilized in the n-pentane. The latter are then separated into saturates, aromatics and resins by MPLC type (Medium Pressure Liquid Chromatography) liquid adsorption chromatography. The part insoluble in n-pentane (NSO and insolubles) is then mixed with the dichloromethane at 44° C. under reflux for 1 hour. Then the solution is filtered: the solute makes up the NSO while the insoluble part corresponds to the “insolubles” fraction.

All the fractions thus separated (NSO, Aromatics, Saturates, Resins, Insolubles) are weighed. One checks that the sum of the masses of the fractions reaches at least 95% of the mass of the sample initially fed into the gold tube. The atomic sulfur mass content is measured in each fraction by elementary analysis, a technique that is well known to the man skilled in the art. It is then possible to calculate the mass of sulfur in each fraction and to deduce the total sulfur distribution in these fractions and in the gas. FIG. 1A shows the evolution, as a function of time t, of the sulfur mass distribution (RMS) in each fraction, for a temperature of 260° C., before aquathermolysis (t_{c}=0), and for two contact times: t_{c}=24 h and t_{c}=203 h. A curve interpolating these three values is also shown in this figure. FIG. 1B also shows the evolution of the sulfur mass distribution in each fraction, for the same contact times, but for a temperature of 320° C.

The total mass of sulfur mₛ present in the sample is also deduced by adding the mass of sulfur contained in each one of the fractions.

We thus obtain:

the sulfur mass distribution in the NSO fraction for a contact time t_{c} and an aquathermolysis temperature Tₚ(S^{NSO)},

the sulfur mass distribution in the insolubles fraction for a contact time t_{c} and an aquathermolysis temperature Tₚ(S^{INS}),

the sulfur mass distribution in the aromatics fraction for a contact time t_{c} and an aquathermolysis temperature Tₚ(S^{RES}),

the sulfur mass distribution in the resin fraction for a contact time t_{c} and an aquathermolysis temperature Tₚ(S^{RES}).

The sulfur mass distribution in the H₂S fraction (S^{H2S}) is also deduced for a contact time t_{c} and an aquathermolysis temperature Tₚ, by means of the distributions of the various fractions and of the mass conservation equation (equation (4)).

Calibration of the Parameters of the Model of Sulfur Distribution Evolution in the Fractions and in the H₂S

As mentioned above, to evaluate the parameters of the kinetic model as a function of temperature, it is necessary to carry out several aquathermolysis experiments at different temperatures, all within the range wherein aquathermolysis has notable effects (200° C.-300° C.), on the time scale of crude petroleum production. The experimental aquathermolysis procedure described above has to be repeated as many times as there are parameters to be calibrated, at different contact times and different temperatures.

The initial state is also calibrated by experimental determination of the sulfur distribution in the initial rock: fraction extractions and separations, weighing and elementary analysis. We thus deduce the sulfur mass distribution in the NSO fraction at t_{c}=0 (S₀^{HSO}), the sulfur mass distribution in the resin fraction at t_{c}=0 (S₀^{RES}), the sulfur mass distribution in the insolubles fraction at t_{c}=0 (S₀^{INS}) and the sulfur mass distribution in the aromatics fraction at t_{c}=0 (S₀^{ARO}).

$$\{ \begin{matrix}\begin{matrix}\begin{matrix}\begin{matrix}{S}^{NSO} ( t = 0 ) = {S}_{0}^{NSP} \\ {S}^{RES} ( t = 0 ) = {S}_{0}^{RES}\end{matrix} \\ {S}^{H 2 S} ( t = 0 ) = 0\end{matrix} \\ {S}^{INS} ( t = 0 ) = {S}_{0}^{INS}\end{matrix} \\ {S}^{ARO} ( t = 0 ) = {S}_{0}^{ARO}\end{matrix} \}$$

In order to calibrate the parameters of the system of equations defining the kinetic model, we use the initial state as well as all the measurements performed during the aquathermolyses carried out in the laboratory, in an inversion engine. Inversion is a technique well known to specialists. In the method according to the invention, this technique allows to optimize the unknown parameters of the model so that the model outputs (the sulfur mass distributions in each modelled fraction) best match the data measured in the laboratory (the sulfur mass distributions in each measured fraction). We therefore define a function evaluating the difference between the measured data and the modelled data. It is possible to use, for example, a function defined as the sum of the quadratic errors between the measured value and the calculated value of each variable Sⁱ (S^{INS}, S^{ARO}, S^{RES}, . . . ). Inversion then consists in seeking the minimum of this function in relation to each kinetic parameter: Aₐ₁, Aₐ₂, . . . , Aₐₙ, A_{b1}, A_{b2}, . . . , A_{bm} and Eₐ₁, Eₐ₂, . . . , Eₐₙ, E_{b1}, E_{b2}, . . . , E_{bm} and α₁₁, α₁₂, α₁₃, . . . , αₙ₁, αₙ₂, αₙ₃ and β₁₁, β₁₂, β₁₃, . . . , βₘ₁, βₘ₂, βₘ₃ and a₁, a₂, . . . , aₙ and b₁, b₂, . . . , bₘ.

The sulfur mass distributions in each fraction are modelled from the first-order kinetic scheme (5) defining the kinetic model, derived from systems (1) and (3), and constrained by system (2) and mass conservation equation (4), as well as by the initial conditions (S₀^{NSO}, S₀^{RES}, S₀^{INS} and S₀^{ARO}). On the other hand, equation (6) of the kinetic model allows, after calibration of this model, to determine the amount of hydrogen sulfide generated during aquathermolysis, as a function of time and temperature.

Estimation of the Mass of Hydrogen Sulfide Produced by a Petroleum Reservoir

The method according to the invention can be applied within the context of steam injection in a petroleum reservoir for enhanced heavy oil recovery. In fact, during such an enhanced recovery, above 200° C., the chemical aquathermolysis reactions between the steam and the reservoir rock have significant effects on the oil production time scale.

Within the context of such an application, the kinetic model is intended to be used lo in a reservoir model for numerical simulation, via a flow simulator, of the production of oil by steam injection and the related H₂S production. The reservoir model must be able to calculate the temperatures, to take account of the H₂S, of the mineral matrix (representing the insolubles fraction) and of the unknowns, and to describe the crude with at least three pseudo-constituents: NSO, C14+ aromatics and C14+ resins.

Evaluation of the hydrogen sulfide production can be done at any time t. In fact, contact time t_{c} is the time t, and the reaction temperature is defined for any time t by a flow simulator known to the man skilled in the art, such as FIRST-RS (IFP, France) for example. In fact, a flow simulator allows, through a reservoir model, to take account of the reservoir conditions (pressure, temperature, porosity, amount of sulfur initially present in the crude) and of the steam injection conditions (pressure, flow rate, temperature, duration).

To perform calibration of the kinetic model, rocks samples from the reservoir, such as cores, are used.

The parameters required for calculation of the hydrogen sulfide production from equation (6) are all defined:

the parameters of the kinetic model are determined from aqueous pyrolysis experiments in an inert and closed medium,

the initial conditions are determined from extractions and separations of the fractions by solvents, then by weighing and elementary analysis,

the mass of sulfur contained in the rock is estimated in the laboratory,

the temperature within the reservoir is estimated by the flow simulator at any time t.

By applying the method to reservoir rock samples (cores, . . . ), it is possible to quantitatively predict the production of hydrogen sulfide (H₂S) when heavy crudes are recovered by steam injection in a petroleum reservoir. It is then possible to limit risks by checking that the H₂S emissions remain below the legal maximum level (10 to 20 vol.ppm according to countries). It is then possible to determine the steam injection conditions required to reduce the H₂S emissions or to dimension H₂S re-injection processes in the reservoir. It is also possible, from this H₂S emissions estimation, to dimension the wellhead acid gas processing plants, or to define production materials suited to withstand H₂S gases.

Result of an Implementation of the Method

The method according to the invention is applied within the context of steam injection in a petroleum reservoir for enhanced heavy oil recovery.

According to the embodiment example described above, four temperatures are selected within the sensitive range (200° C.-300° C.), and one slightly above this range: 240° C., 260° C., 280° C., 300° C. and 320° C. Still according to this embodiment, for each pyrolysis carried out at different temperatures, the measurements are performed for two different contact times t_{c}: t_{c}=24 h and t_{c}=203 h.

We assume that only two parallel reactions for the sulfur in the NSO (n=2) and two 5 parallel reactions for the sulfur in the resins (m=2) allow the experimental data obtained to be described:

$$\{ \begin{matrix}\begin{matrix}\begin{matrix}{S}^{NSO} {\to }^{{a}_{1 ,} {k}_{a 1} ( T )} {α}_{11} {S}^{{H}_{2} S} + {α}_{12} {S}^{INS} + {α}_{13} {S}^{ARO} \\ {S}^{NSO} {\to }^{{a}_{2 ,} {k}_{a 2} ( T )} {α}_{21} {S}^{{H}_{2} S} + {α}_{22} {S}^{INS} + {α}_{23} {S}^{ARO}\end{matrix} \\ {S}^{RES} {\to }^{{b}_{1 ,} {k}_{b 1} ( T )} {β}_{11} {S}^{{H}_{2} S} + {β}_{12} {S}^{INS} + {β}_{13} {S}^{ARO}\end{matrix} \\ {S}^{RES} {\to }^{{b}_{2 ,} {k}_{b 2} ( T )} {β}_{21} {S}^{{H}_{2} S} + {β}_{22} {S}^{INS} + {β}_{23} {S}^{ARO}\end{matrix} \} , ∀ t \geq 0$$

$$with {S}^{NSO} + {S}^{{H}_{2} S} + {S}^{INS} + {S}^{ARO} + {S}^{RES} = 1 , ∀ t \geq 0.$$

We thus consider two time constants for the degradation of the sulfur in the NSO:

$$\{ \begin{matrix}{k}_{a 1} ( T ) = {A}_{a 1} exp ( - \frac{{E}_{a 1}}{R . T} ) \\ {k}_{a 2} ( T ) = {A}_{an} exp ( - \frac{{E}_{an}}{R . T} )\end{matrix} \} , ∀ T \geq {20}^{∘} C .$$

and we also consider two time constants for the degradation of the sulfur in the resins:

$$\{ \begin{matrix}{k}_{b 1} ( T ) = {A}_{b 1} exp ( - \frac{{E}_{a 1}}{R . T} ) \\ {k}_{b 2} ( T ) = {A}_{bm} exp ( - \frac{{E}_{bm}}{R . T} )\end{matrix} \}$$

We furthermore measure that there is no sulfur initially in the insolubles fraction in the rock.

$$\{ \begin{matrix}{S}^{NSD} ( t = 0 ) = {S}_{0}^{NSO} \\ {S}^{RES} ( t = 0 ) = {S}_{0}^{RES} \\ {S}^{H 2 S} ( t = 0 ) = 0 \\ {S}^{INS} ( t = 0 ) = 0 \\ {S}^{ARO} ( t = 0 ) = {S}_{0}^{ARO}\end{matrix} \}$$

Considering the unknowns of the kinetic model defined, there are 24 parameters to be calibrated:

| | |
|---|---|
| α₁₁, α₁₂, α₁₃ | α₂₁, α₂₂, α₂₃ |
| β₁₁, β₁₂, β₁₃ | β₂₁, β₂₂, β₂₃ |
| a₁, a₂ | b₁, b₂ |
| Aₐ₁, Aₐ₂ | A_{b1}, A_{b2} |
| Eₐ₁, Eₐ₂ | E_{b1}, E_{b2} |

By taking into account the six closure equations (2), the number of unknowns is decreased to 18.

The number of degrees of freedom can still be decreased by fixing the pre-exponential factors to an arbitrary but realistic value:
Aₐ₁=Aₐ₂=A_{b1}=A_{b2}=10¹⁴s⁻¹.

The number of degree of freedom of the model is thus reduced to 14.

In order to determine the value of these 14 unknown parameters, we carried out ten aquathermolysis experiments that provided 55 experimental values (5 fractions×5 temperatures×2 contact times+5 values at t=0). Thus, the system is actually well constrained. The experimental results are described in Table 1, wherein “wt %” means percentage by mass (and not by volume):

TABLE 1

| Aquathermolysis | | | | | | | |
|---|---|---|---|---|---|---|---|
| temperature T | Contact | | | | | | |
| (° C.) | time t_{c} (h) | S^{ARO} (wt %) | S^{RES} (wt %) | S^{NSO} (wt %) | S^{INS} (wt %) | S^{H2S} (wt %) | Sum |
| 320° C. | 0 | 17% | 45% | 38% | 0% | 0% | 100% |
| | 24 | 19% | 32% | 23% | 20% | 6% | 100% |
| | 203 | 27% | 25% | 15% | 20% | 13% | 100% |
| 300° C. | 0 | 17% | 45% | 38% | 0% | 0% | 100% |
| | 24 | 18% | 34% | 27% | 18% | 2% | 100% |
| | 203 | 23% | 33% | 23% | 18% | 4% | 100% |
| 280° C. | 0 | 17% | 45% | 38% | 0% | 0% | 100% |
| | 24 | 21% | 43% | 36% | 0% | 0% | 100% |
| | 203 | 22% | 38% | 25% | 15% | 1% | 100% |
| 260° C. | 0 | 17% | 45% | 38% | 0% | 0% | 100% |
| | 24 | 20% | 44% | 36% | 0% | 0% | 100% |
| | 203 | 20% | 39% | 28% | 13% | 1% | 100% |
| 240° C. | 0 | 17% | 45% | 38% | 0% | 0.0% | 100% |
| | 24 | 18% | 43% | 39% | 0% | 0.1% | 100% |

Furthermore, the measured initial conditions are as follows:
S₀^{NSO}=38% S₀^{RES}=45%
S₀^{INS}=0% S₀^{ARO}=17%

After obtaining these experimental values, an inversion technique is used to determine the unknown parameters. In this example, an extended Levenberg-Marquardt algorithm under constraint is used. This algorithm is described for example in the following documents:

Levenberg, K. “A Method for the Solution of Certain Problems in Least Squares.” Quart. Appl. Math. 2, 164-168, 1944.

Marquardt, D. “An Algorithm for Least-Squares Estimation of Nonlinear Parameters.” SIAM J. Appl. Math. 11, 431-441, 1963.

Inversion then give the following results:

| | | |
|---|---|---|
| α₁₁ = 100% | α₁₂ = 0% | α₁₃ = 0% |
| α₂₁ = 33% | α₂₂ = 60% | α₂₃ = 7% |
| β₁₁ = 40% | β₁₂ = 38% | β₁₃ = 22% |
| β₂₁, = 100% | β₂₂, = 0% | β₂₃ = 0%, |
| a₁ = 33% | a₂ = 67% | |
| b₁ = 22% | b₂ = 78% | |
| Eₐ₁ = 48.5 kcal/mol | Eₐ₂ = 54.6 kcal/mol | |
| E_{b1} = 48.8 kcal/mol | E_{b2} = 55.2 kcal/mol | |
| Aₐ₁ = Aₐ₂ = A_{b1} = A_{b2} = 10¹⁴ s⁻¹. | | |

Thus, the following kinetic scheme is deduced therefrom:

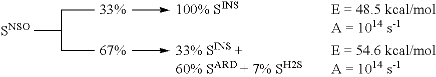

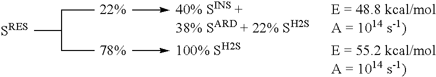

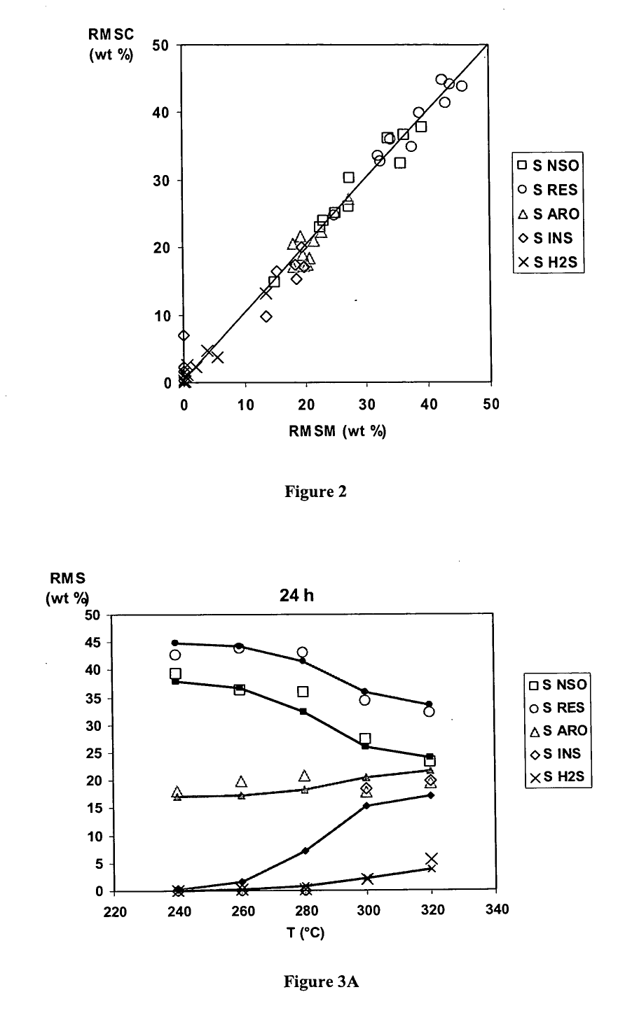

FIG. 2 shows a comparison between the numerical results and the experimental results. The ordinate axis represents the sulfur mass distributions in each fraction (S^{NSO}, S^{RES}, S^{ARO}, S^{INS} and S^{H}^{₂}^{S}) calculated from the method (RMSC), and the abscissa axis represents the measured sulfur mass distributions in each fraction (RMSM).

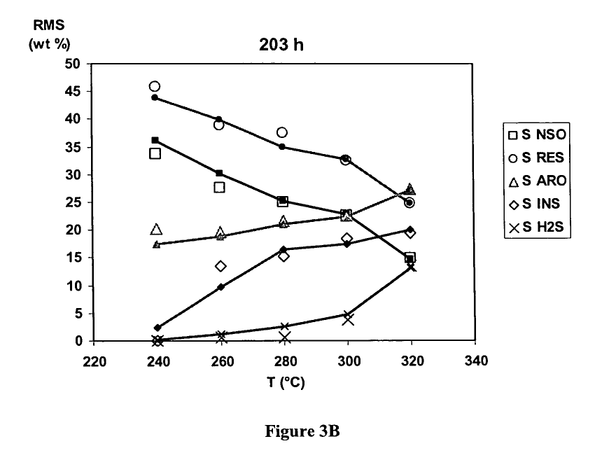

FIG. 3A shows the evolution, as a function of temperature T, of the sulfur mass distribution (RMS) in the various fractions for a 24-h contact time (t_{c}), for the five experimental temperatures (Tₚ) selected. The hollow symbols are the measurements, and the curves are the results of the kinetic model.

FIG. 3B shows the evolution, as a function of temperature T, of the sulfur mass distribution (RMS) in the various fractions for a 203-h contact time (t_{c}), for the five experimental temperatures (Tₚ) selected. The hollow symbols are the measurements and the curves are the results of the kinetic model.

The method according to the invention thus allows to determine and to calibrate a fine kinetic model describing the evolution, not of the crude fractions (NSO, aromatics, resins), but of the sulfur distribution in these fractions, while disregarding the “Saturates” fraction of the crude because sulfur does not combine therewith, but by taking into account the “Insolubles” fraction that involves the mineral and sometimes a small organic proportion. Furthermore, the method allows to respect the sulfur mass conservation principle in the various fractions during contact with steam.

The method is thus very accurate for evaluating the mass of hydrogen sulfide (H₂S) produced by aquathermolysis within a rock containing crude oil. The method can then be used to quantitatively predict the production of hydrogen sulfide (H₂S) when heavy crudes are recovered by steam injection in a petroleum reservoir. The method then allows to check whether the H₂S emissions remain below the legal maximum level (around 10 to 20 vol.ppm according to countries) and to deduce therefrom the steam injection conditions or to dimension H₂S re-injection processes and wellhead acid gas processing plants, or to select sufficiently resistant production materials.

1) A method for constructing a kinetic model allowing to estimate the mass of hydrogen sulfide produced by a rock containing crude oil and subjected to contact with steam at a temperature T for a contact time t, generating an aquathermolysis reaction, characterized in that the method comprises the following stages:
a) describing the rock, the crude oil and the hydrogen sulfide produced according to a characterization by chemical compound fractions comprising at least the following fractions:
the NSO, aromatics and resin fractions to describe the oil,
the insolubles fraction containing compounds that are insoluble in dichloromethane and n-pentane, to describe the rock,
the hydrogen sulfide fraction to describe the hydrogen sulfide,
b) defining a kinetic model describing, from kinetic parameters, the mass of hydrogen sulfide produced as a function of said contact time t, as a function of said temperature T and as a function of the evolution of the sulfur distribution in said chemical compound fractions, wherein:
at least part of the sulfur contained in said NSO fraction produces hydrogen sulfide and at least another part is incorporated in said insolubles and aromatics fractions,
at least part of the sulfur contained in said resin fraction produces hydrogen sulfide and at least another part is incorporated in said insolubles and aromatics fractions,
all of the sulfur initially contained in the oil and the rock is entirely dispersed in at least one of said chemical compound fractions during aquathermolysis,
c) calibrating said kinetic parameters from aqueous pyrolysis experiments carried out on at least one sample of said rock.

2) A method as claimed in claim 1, wherein at least as many pyrolysis experiments as there are kinetic parameters to be calibrated are carried out.

3) A method as claimed in claim 1, wherein said aqueous pyrolysis experiments are carried out for various temperatures and various contact times.

4) A method as claimed in claim 3, wherein the various temperatures are selected within a range wherein aquathermolysis has notable effects.

5) A method as claimed in claim 3, wherein the various temperatures are above 200° C.

6) A method as claimed in claim 3, wherein the various temperatures are below 300° C.

7) A method as claimed in claim 3, wherein the following values are measured after said pyrolysis experiments:
the mass of hydrogen sulfide produced for each temperature and each contact time between the steam and the oil,
the sulfur mass distribution in each one of said fractions.

8) A method as claimed in claim 7, wherein the sulfur mass distribution in each fraction is measured by extraction and separation of the fractions by means of solvents, then by weighing and elementary analysis of the fractions.

9) A method as claimed in claim 7, wherein the mass of hydrogen sulfide produced after said pyrolysis experiments is measured by gas chromatography.

10) A method as claimed in claim 1, wherein initial conditions of said kinetic model are determined from rock samples by separating, prior to pyrolysis, said fractions by means of solvents and by performing elementary analyses of said fractions thus separated.

11) A method as claimed in claim 1, wherein said kinetic parameters are calibrated by means of an inversion technique.

12) A method as claimed in claim 1, wherein the mass of hydrogen sulfide produced by a petroleum reservoir during crude oil recovery by steam injection in said reservoir is estimated by carrying out the following stages:
calibrating said parameters from rock samples from said reservoir,
estimating said mass of hydrogen sulfide produced by said reservoir at any time, by means of a reservoir model and from said kinetic model.

13) A method as claimed in claim 12, wherein it is checked that the mass of hydrogen sulfide produced by said petroleum reservoir remains below the legal maximum level.

14) A method as claimed in claim 12, wherein steam injection conditions necessary to reduce H₂S emissions are determined.

15) A method as claimed in claim 12, wherein processes for re-injecting H₂S into the reservoir are dimensioned.

16) A method as claimed in claim 12, wherein wellhead acid gas processing plants are dimensioned.
